(19) United States
(12) Patent Application Publication
(10) Pub. No.: US 2010/0251107 A1
(43) Pub. Date: Sep. 30, 2010

(54) HANDHELD TERMINAL AND METHOD OF EDITING DATA USING TOUCH INPUT

(75) Inventor: Myung Seob OH, Gimhae-si (KR)

Correspondence Address: H.C. PARK & ASSOCIATES, PLC, 8500 LEESBURG PIKE, SUITE 7500, VIENNA, VA, 22182, US

(73) Assignee: Pantech Co., Ltd., Seoul (KR)

(21) Appl. No.: 12/729,464

(22) Filed: Mar. 23, 2010

(30) Foreign Application Priority Data
Mar. 26, 2009 (KR) 10-2009-0025768

(51) Int. Cl. G06F 3/01; G06F 17/24; G06F 3/033

(52) U.S. Cl. 715/269; 715/702; 715/256; 715/863

(57) ABSTRACT

Provided is a method of editing data and a handheld terminal using the method. The handheld terminal includes: a recognition unit to recognize a touch input associated with a correction code on a screen; a discernment unit to discern an editing function corresponding to the recognized touch input; and an editing unit to edit data provided on the screen according to the discerned editing function.

### CROSS-REFERENCE TO RELATED APPLICATION

This application claims priority from and the benefit of Korean Patent Application No. 10-2009-0025768, filed on Mar. 26, 2009, which is hereby incorporated by reference for all purposes as if fully set forth herein.

### BACKGROUND OF THE INVENTION

1. Field of the Invention

Exemplary embodiments of the present invention relate to a method of editing data and a handheld terminal using the method.

2. Discussion of the Background

Due to development of communication technologies, a handheld terminal may provide various services such as wireless Internet services, video call services, and E-mail services. In recent years, to effectively provide these various services, technologies of the handheld terminal are being gradually improved.

In response to this trend, a display unit for the handheld terminal has been developed as a touch screen capable of being used for input as well as displaying. The handheld terminal, including the touch screen, may have improved usability for a user due to an enlarged size of the touch screen, and also due to simultaneously displaying and inputting, as compared to a screen of an existing liquid crystal display (LCD).

However, when editing text, an input such as a menu selection, a deletion, a font property, and the like may be performed using a menu bar displayed on a lower portion of a screen, similar to an input scheme of an existing input pad.

FIG. 1 illustrates an example of editing characters on a handheld terminal according to an embodiment in the conventional art.

As shown on a display 110, when typographical errors such as ‘than’ are created while writing a message, a user may touch-input ‘delete’ from the menu bar provided on the lower portion of the screen through, thereby deleting ‘than’. That is, the user may touch-input ‘delete’ twice to delete ‘than’, and may re-input ‘then’ as shown in a display 120.

In the above described editing scheme, a cursor may be required to be positioned on a character intended to be deleted, and a virtual deletion button disposed in the lower portion of the screen may be required to be pushed, so that the character may be deleted. However, as described above, a conventional editing scheme may have a problem in that an editing scheme of an existing input pad may be only used as is rather than using advantages of the touch screen.

### SUMMARY OF THE INVENTION

Exemplary embodiments of the present invention provide to effectively edit data according to an editing function corresponding to a recognized touch input on a screen using advantages of a touch screen.

Exemplary embodiments of the present invention also provide to delete data, insert or delete a whitespace, paste other data, replace data with other data, input new data, or decorate data according to an editing function corresponding to a recognized touch input, when recognizing the touch input including coordinate information associated with a correction code.

Additional features of the invention will be set forth in the description which follows, and in part will be apparent from the description, or may be learned by practice of the invention.

An exemplary embodiment of the present invention discloses a handheld terminal, comprising a recognition unit to recognize a touch input associated with a correction code on a screen; a discernment unit to discern an editing function corresponding to the recognized touch input; and an editing unit to edit data provided on the screen according to the discerned editing function.

An exemplary embodiment of the present invention also discloses a method of editing data, comprising recognizing a touch input associated with a correction code on a screen; discerning an editing function corresponding to the recognized touch input; and editing data provided on the screen according to the discerned editing function.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 illustrates an example of editing characters on a handheld terminal according to an embodiment in the conventional art;

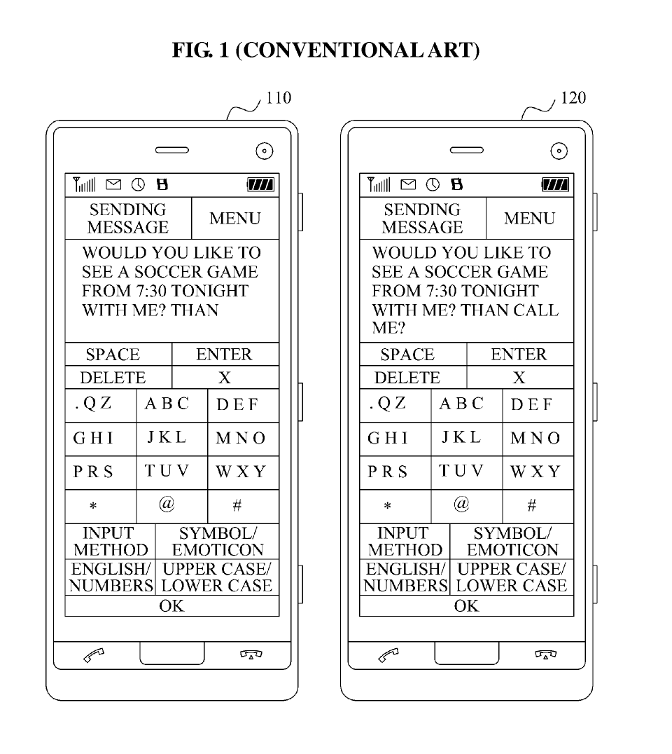

FIG. 2 is a block diagram illustrating a configuration of a handheld terminal according to an exemplary embodiment of the present invention;

FIG. 3 is a diagram illustrating a structure of a storing unit included in a handheld terminal according to an exemplary embodiment of the present invention;

FIG. 4 is a diagram illustrating an example of performing an editing function associated with ‘delete’ according to a touch input in a handheld terminal, according to an exemplary embodiment of the present invention;

FIG. 5 is a diagram illustrating an example of performing an editing function associated with ‘space’ according to a touch input in a handheld terminal, according to an exemplary embodiment of the present invention;

FIG. 6 is a diagram illustrating an example of performing an editing function associated with ‘join’ according to a touch input in a handheld terminal, according to an exemplary embodiment of the present invention;

FIG. 7 is a diagram illustrating an example of performing an editing function associated with ‘replace’ according to a touch input in a handheld terminal, according to an exemplary embodiment of the present invention;

FIG. 8 is a diagram illustrating an example of performing an editing function associated with ‘cut and paste’ according to a touch input in a handheld terminal, according to an exemplary embodiment of the present invention;

FIG. 9 is a diagram illustrating an example of performing an editing function associated with ‘decorate’ according to a touch input in a handheld terminal, according to an exemplary embodiment of the present invention; and

FIG. 10 is a flowchart illustrating a method of editing data according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

A handheld terminal as used throughout the present specification includes a notebook computer, a cellular phone, a personal communication service (PCS) phone, a satellite/terrestrial Digital Multimedia Broadcasting (DMB) phone, a personal digital assistant (PDA), a portable media player (PMP), a MP 3 player, and the like.

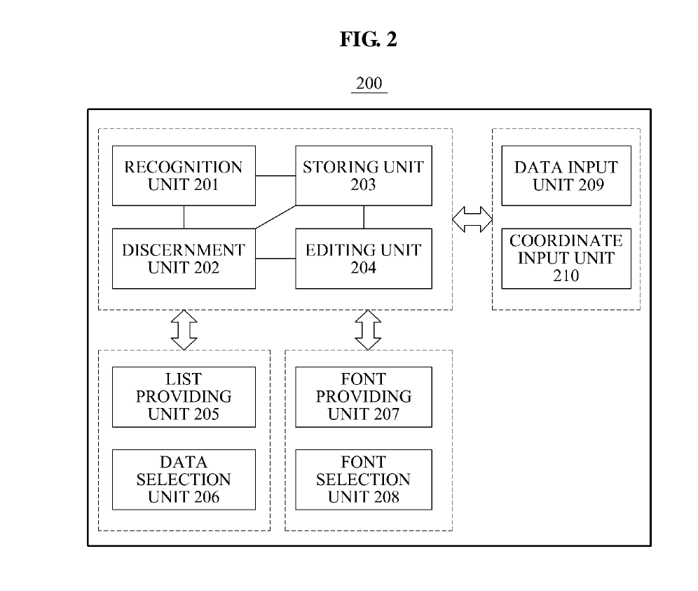

FIG. 2 is a block diagram illustrating a configuration of a handheld terminal 200 according to an exemplary embodiment of a present invention.

As illustrated in FIG. 2, the handheld terminal 200 includes a recognition unit 201 to recognize a touch input associated with a correction code on a screen, a discernment unit 202 to discern an editing function corresponding to the recognized touch input, and an editing unit 204 to edit data provided on the screen according to the discerned editing function.

The touch input may include coordinate information associated with the correction code, and the editing function may include delete, space, join, insert, replace, cut and paste, and decorate. Accordingly, the discernment unit 202 may discern any one of delete, space, join, insert, replace, cut and paste, and decorate as the editing function corresponding to the coordinate information, and the editing unit 204 may edit characters displayed on the screen according to the discerned editing function.

The handheld terminal 200 according to an exemplary embodiment of the present invention may further include a storing unit 203 to store the editing function corresponding to the correction code. The discernment unit 202 may discern, in the storing unit 203, the editing function corresponding to the correction code with respect to the recognized touch input. For example, similar to an editing scheme where a school essay is corrected by a teacher using a red pencil, the editing function corresponding to each of the correction codes may be designated.

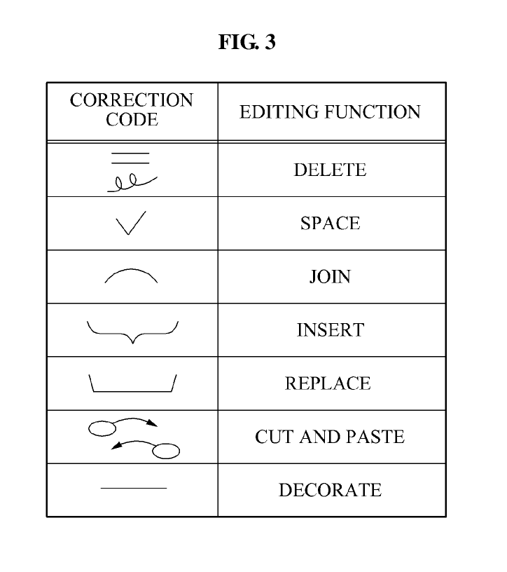

FIG. 3 is a diagram illustrating a structure of a storing unit included in a handheld terminal according to an exemplary embodiment of the present invention.

As illustrated in FIG. 3, the storing unit 203 may associate an editing function of ‘delete’ with a correction code (═) or a correction code ( [symbol] ), associate an editing function of ‘space’ with a correction code ( [symbol] ), associate an editing function of ‘join’ with a correction code ( [symbol] ), associate an editing function of ‘insert’ with a correction code ( [symbol] ), associate an editing function of ‘replace’ with a correction code ( [symbol] ), associate an editing function of ‘cut and paste’ with a correction code ( [symbol] ), and associate an editing function of ‘decorate’ with a correction code ( [symbol] ).

The correction codes may be differently established according to respective editing functions based on a pattern for a touch input of a user. Accordingly, the correction codes illustrated in FIG. 3 are merely examples, and other correction codes not illustrated in FIG. 3 may be established according to respective editing functions.

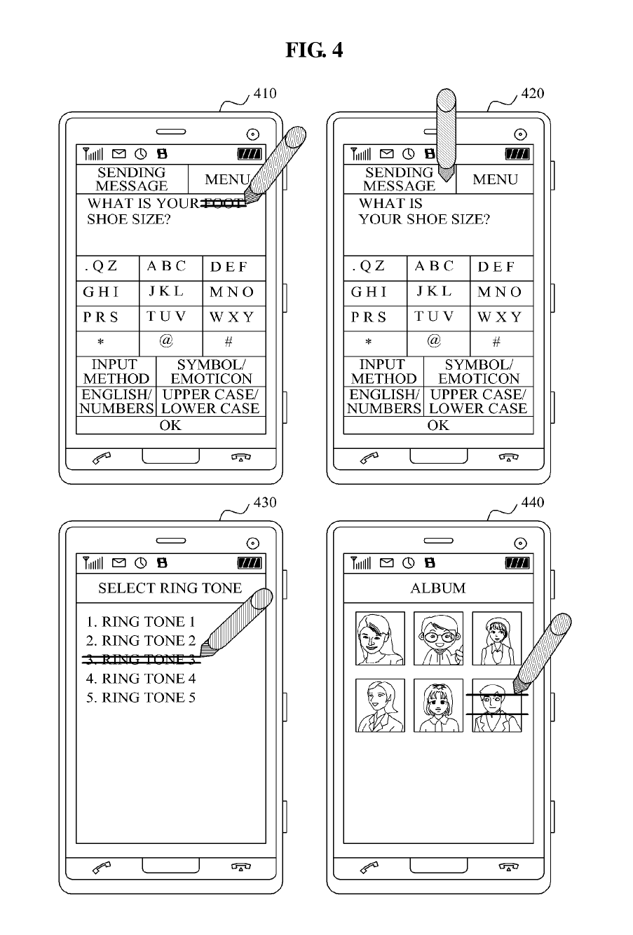

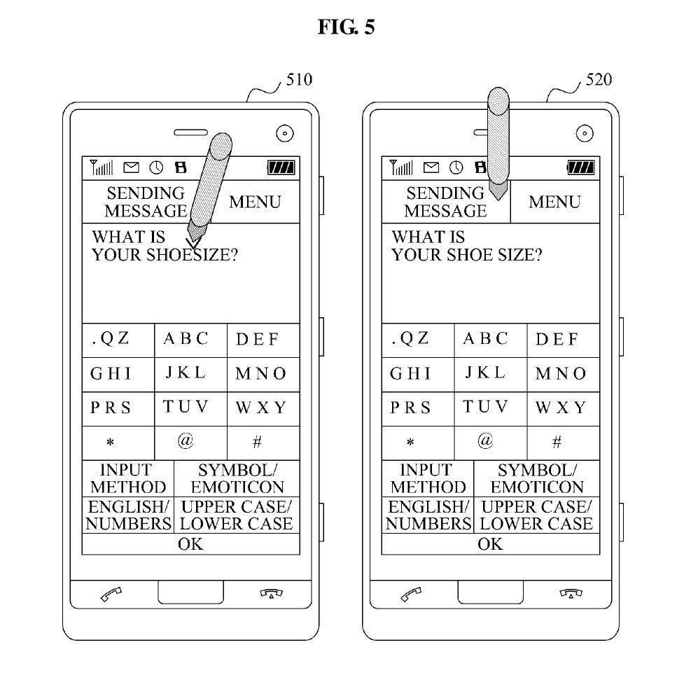

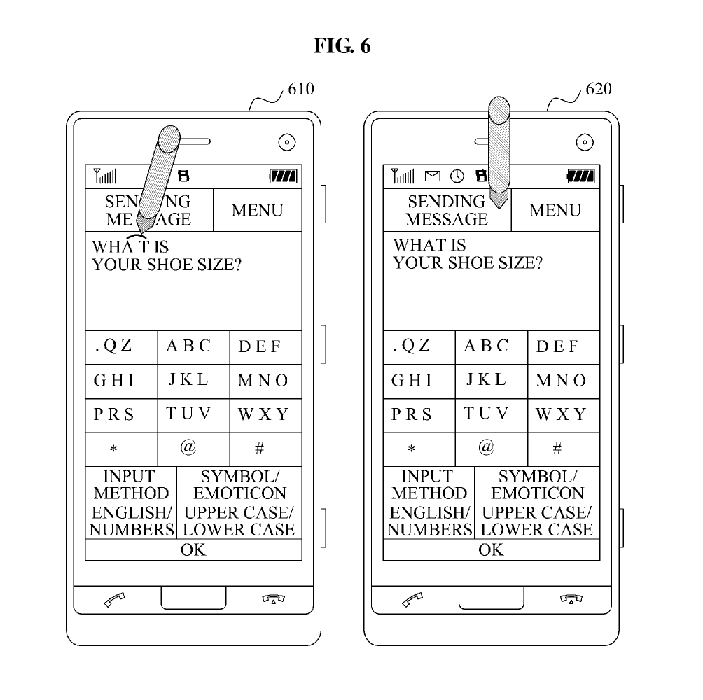

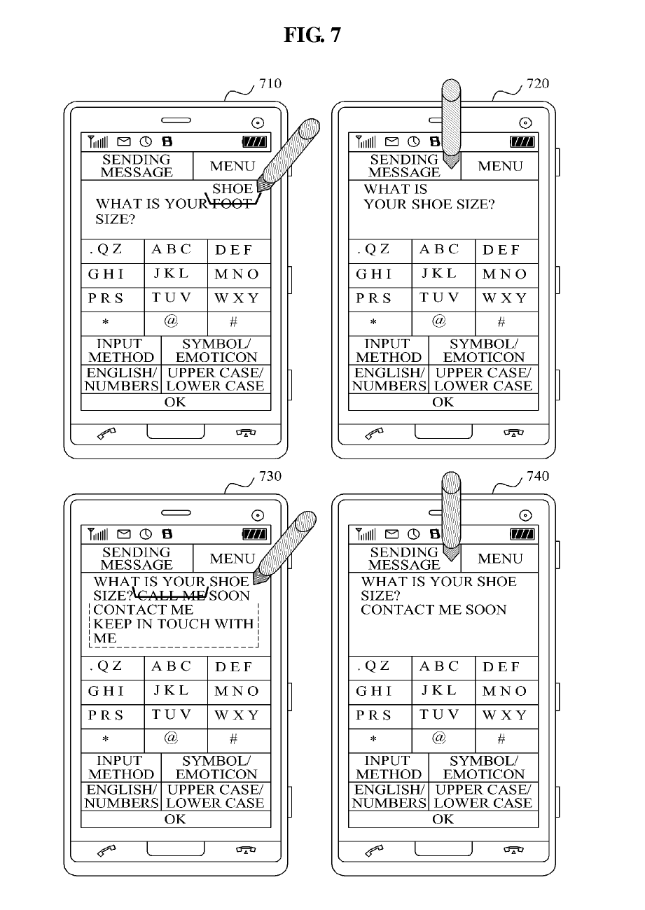

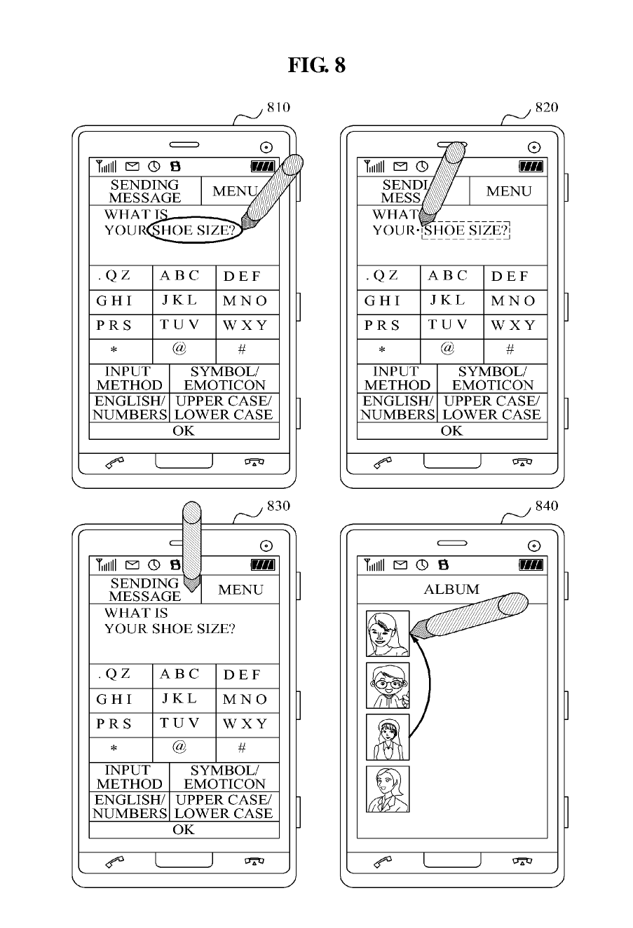

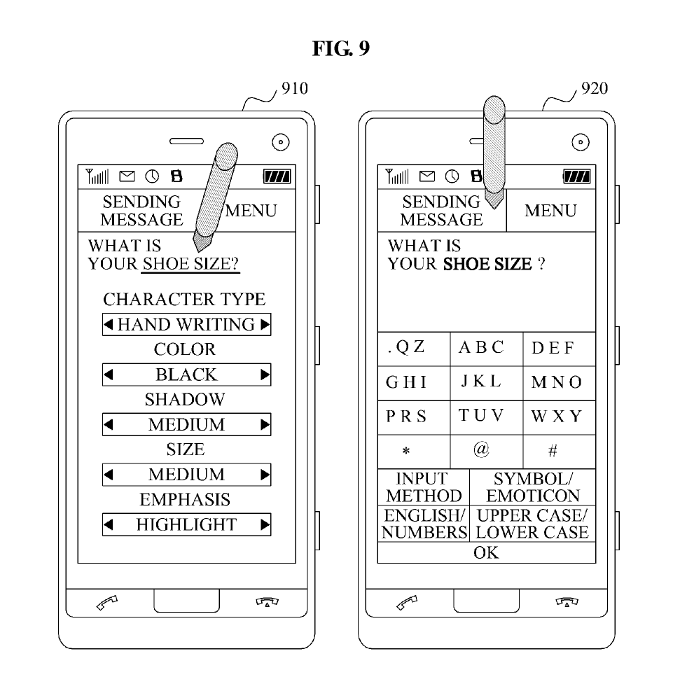

Examples of the respective editing functions will be described in detail with reference to FIG. 4, FIG. 5, FIG. 6, FIG. 7, FIG. 8, and FIG. 9.

FIG. 4 is a diagram illustrating an example of performing an editing function associated with ‘delete’ according to a touch input in a handheld terminal, according to an exemplary embodiment of the present invention.

As illustrated in a display 410, the recognition unit 201 may recognize, from a user, a touch input associated with an editing function while writing a message. In the recognition unit 201, the touch input may be recognized using a touch pen and other tools, or through a close-contact on a screen using a part of the human body of the user. The recognized touch input may include coordinate information with respect to a character position shown as ‘foot’. Accordingly, the discernment unit 202 may discern a touch input associated with a correction code (═), displayed on the characters ‘foot’, as an editing function of ‘delete’.

Therefore, as illustrated in a display 420, the editing unit 204 may delete the character ‘foot’ included in the coordinate information. Here, data provided on the screen may be interpreted as characters.

As illustrated in a display 430, the recognition unit 201 may recognize a touch input on the screen in which a menu of ‘select ring tone’ is provided. The recognized touch input may include coordinate information with respect to a position of contents designated as ‘ring tone 3’. Accordingly, the discernment unit 202 may discern a touch input associated with a correction code (═), displayed on the contents ‘ring tone 3’, as the editing function of ‘delete’. In this case, the editing unit 204 may delete ‘ring tone 3’ from a ring tone list. Thereafter, a ring tone list may include a ring tone 1, a ring tone 2, a ring tone 4, and a ring tone 5. Here, data provided on the screen may be interpreted as contents.

As illustrated in a display 440, the recognition unit 201 may recognize a touch input on a screen in which a menu ‘album’ is provided. The recognized touch input may include coordinate information with respect to a position on which a ‘sixth’ photo from among provided photos is displayed. Accordingly, the discernment unit 202 may discern a touch input associated with a correction code (═), displayed on the ‘sixth’ photo, as the editing function ‘delete’. In this case, the editing unit 204 may delete the ‘sixth’ photo from the album. Therefore, the album may include a first photo to a fifth photo. Here, data provided on the screen may be interpreted as a photo.

That is, the handheld terminal 200 according to an exemplary embodiment of the present invention may edit data included in the menu list such as contents, photos, and the like as well as editing characters, in the same manner as that in the above described character editing.

The touch input associated with ‘delete’, described with reference to FIG. 4, is merely an example, and may be changed and applied depending on example embodiments.

FIG. 5 is a diagram illustrating an example of performing an editing function associated with ‘space’ according to a touch input in a handheld terminal according to an exemplary embodiment of the present invention.

As illustrated in a display 510, the recognition unit 201 may recognize a touch input associated with a correction code ( [symbol] ), displayed between characters ‘shoesize’. The recognized touch input may include coordinate information with respect to a position in which ‘shoesize’ is displayed. Accordingly, the discernment unit 202 may discern a touch input associated with a correction code ( [symbol] ) as an editing function of ‘space’.

In this case, as illustrated in a display 520, the editing unit 204 may insert a space in a position corresponding to the coordinate information. That is, the editing unit 204 may insert a space between the characters displayed as ‘shoesize’, thereby obtaining edited characters ‘shoe size’. Therefore, characters displayed as ‘what is your shoesize?’ may be edited into ‘what is your shoe size?’. Here, data provided on the screen may be interpreted as characters.

The touch input associated with ‘space’, described with reference to FIG. 5, is merely an example, and may be changed and applied depending on example embodiments.

FIG. 6 is a diagram illustrating an example of performing an editing function associated with ‘join’ according to a touch input in a handheld terminal, according to an exemplary embodiment of the present invention.

As illustrated in a display 610, the recognition unit 201 may recognize a touch input associated with a correction code ( [symbol] ), displayed between characters ‘wha’ and ‘t’. The recognized touch input may include coordinate information with respect to a position in which ‘wha’ and ‘t’ is displayed. Accordingly, the discernment unit 202 may discern a touch input associated with a correction code ( [symbol] ) as an editing function ‘join’.

In this case, as illustrated in a display 620, the editing unit 204 may delete a whitespace in a position corresponding to the coordinate information. That is, the editing unit 204 may delete the whitespace between characters displayed as ‘wha t’, thereby obtaining edited characters ‘what’. Therefore, characters displayed as ‘wha t is your shoe size?’ may be edited into ‘what is your shoe size?’.

The touch input associated with ‘join’, described with reference to FIG. 6, is merely an example, and may be changed and applied depending on example embodiments.

FIG. 7 is a diagram illustrating an example of performing an editing function associated with ‘replace’ according to a touch input in a handheld terminal, according to an exemplary embodiment of the present invention.

As illustrated in a display 710, the recognition unit 201 may recognize a touch input associated with a correction code ( [symbol] ), displayed between characters ‘foot size’. The recognized touch input may include coordinate information with respect to a position in which ‘foot size’ is displayed. Accordingly, the discernment unit 202 may discern the touch input associated with the correction code ( [symbol] ) as an editing function ‘replace’.

The handheld terminal 200 according to an exemplary embodiment of the present invention may further include an input unit 209 to input data. The data input unit 209 may input characters ‘shoe’. Here, data provided on the screen may be interpreted as characters. In this case, as illustrated in a display 720, the editing unit 204 may delete characters included in the coordinate information, and insert the inputted characters ‘shoe’ to replace the deleted characters.

Although not illustrated, the recognition unit 201 may recognize a touch input associated with a correction code ( [symbol] ), displayed in front of characters ‘foot’, and the data input unit 209 may input characters ‘shoe’. Accordingly, the discernment unit 202 may discern the touch input associated with the correction code ( [symbol] ) as an editing function ‘insert’, and the editing unit 204 may insert characters ‘shoe’ in a position corresponding to the coordinate information.

The handheld terminal 200 according to an exemplary embodiment of the present invention may further include a list providing unit 205 to provide a data list including data and a data selection unit 206 to select first data from the provided data list.

In this case, as illustrated in a display 730, the recognition unit 201 may recognize a touch input associated with a correction code ( [symbol] ), displayed on characters ‘call me’. Accordingly, the list providing unit 205 may provide a data list including data such as ‘call me’, ‘contact me’, and the like. The handheld terminal 200 may store frequently used data (phrases) in a memory, and the list providing unit 205 may provide a data list including phrases associated with phrases stored in the memory or inputted characters. The data selection unit 206 may select a desired first data ‘call me’ of a user from among the data list.

As illustrated in a display 740, the editing unit 204 may delete the characters ‘call me’ included in the coordinate information, and insert the selected first data ‘contact me’ to replace the deleted characters.

The touch input associated with ‘replace’, described with reference to FIG. 7, is merely an example, and may be changed and applied depending on example embodiments.

FIG. 8 is a diagram illustrating an example of performing an editing function associated with ‘cut and paste’ according to a touch input in a handheld terminal, according to an exemplary embodiment of the present invention.

As illustrated in a display 810, the recognition unit 201 may recognize a touch input associated with a correction code ( [symbol] ), displayed on characters ‘shoe size’. The recognized touch input may include first coordinate information with respect to a position displayed as characters ‘shoe size’. Accordingly, the discernment unit 202 may discern the touch input associated with the correction code ( [symbol] ) as an editing function ‘cut’. Here, the correction code ( [symbol] ) illustrated in FIG. 8, although differently shown from the correction code ( [symbol] ) illustrated in FIG. 3, may join the first coordinate information ( [symbol] ) and second coordinate information ( [symbol] ).

The handheld terminal 200 according to an exemplary embodiment of the present invention may further include a coordinate input unit 210 to input second coordinate information. As illustrated in a display 820, the coordinate input unit 210 may input the second coordinate information behind characters ‘your’. Here, the editing unit 204 may activate characters ‘shoe size’, whereby characters intended to be moved may be distinct from other characters.

As illustrated in a display 830, the editing unit 204 may delete characters included in the first coordinate information, and insert the deleted characters in a position corresponding to the second coordinate information. That is, the editing unit 204 may cut characters ‘shoe size’ from the first coordinate information, and may paste the cut characters behind ‘your’, that is, the second coordinate information. Consequently, the editing unit 204 may edit ‘what shoe size is your?’ into ‘what is your shoe size?’.

As illustrated in a display 840, the recognition unit 201 may recognize a touch input including first coordinate information with respect to a position where a third photo is displayed on a screen in which an ‘album’ menu is provided. The touch input may be an input to select the third photo. After the third photo is inputted, the coordinate input unit 210 may input second coordinate information being positioned where the first photo is displayed. In this case, the discernment unit 202 may discern the touch input as an editing function ‘cut’. Accordingly, the editing unit 204 may move the third photo to a position of the first photo in the album. That is, the editing unit 204 may delete the third photo, insert the deleted third photo into the position of the first photo, move the first photo to a position of a second photo, and move the second photo to a position of the third photo. Accordingly, positions of the photos included in the album may be changed.

That is, the handheld terminal 200 according to an exemplary embodiment of the present invention may edit data included in a menu list such as contents, photos, and the like, as well as editing characters in the same manner as that in the above described character editing.

The touch input associated with ‘cut and paste’, described with reference to FIG. 8, is merely an example, and may be changed and applied depending on example embodiments.

FIG. 9 is a diagram illustrating an example of performing an editing function associated with ‘decorate’ according to a touch input in a handheld terminal, according to an exemplary embodiment of the present invention.

As illustrated in a display 910, the recognition unit 201 may recognize a touch input associated with a correction code ( [symbol] ), displayed under characters ‘shoe size’. The touch input may include coordinate information with respect to a position where the ‘shoe size’ is displayed. Accordingly, the discernment unit 202 may discern the touch input associated with the correction code ( [symbol] ) as an editing function ‘decorate’.

The handheld terminal 200 according to an exemplary embodiment of the present invention may further include a font providing unit to provide a font property including any one of a character type, a color, a shadow, a size, and an emphasis, and a font selection unit to select the font property including any one of the character type, the color, the shadow, the size, and the emphasis. The character type may be an appearance of the character such as Gothic type, the color may be a color of the character, the shadow may be brightness of the character, the size may be a size of the character, and the emphasis may be an emphasis of the character such as a highlight, bold type, and the like. Accordingly, the font providing unit 207, as shown in a display 910, may provide the font property including any one of the character type, the color, the shadow, the size, and the emphasis, and the font selection unit 208 may receive a selection, by a user, of any one of the character type, the color, the shadow, the size, and the emphasis.

As illustrated in a display 920, the editing unit may replace characters ‘shoe size’ with the selected font property. Here, when the font property is selected as a strong shadow, the editing unit 204 may replace the characters ‘shoe size’ with bold characters.

The touch input associated with ‘decorate’, described with reference to FIG. 9, is merely an example, and may be changed and applied depending on example embodiments.

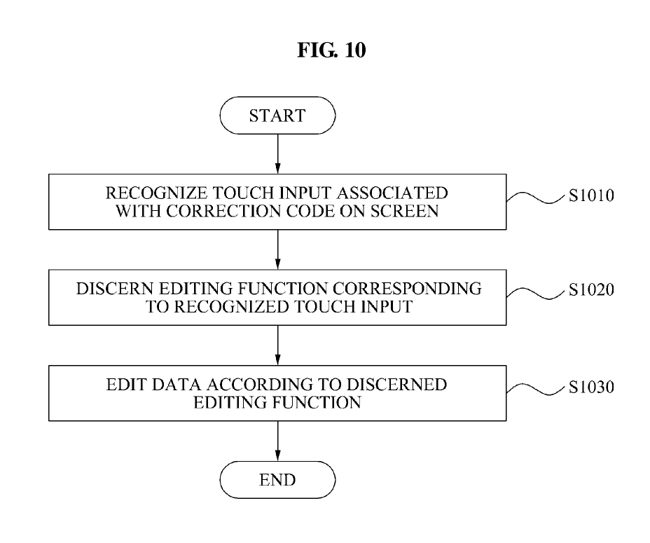

FIG. 10 is a flowchart illustrating a method of editing data according to an exemplary embodiment of the present invention.

The method of editing data may be implemented by the handheld terminal 200 according to an exemplary embodiment of the present invention. Accordingly, FIG. 10 will be described with reference to FIG. 2.

In operation S1010, the recognition unit 201 may recognize a touch input associated with a correction code on a screen. The touch input may include coordinate information associated with the correction code.

In operation S1020, the discernment unit 202 may discern an editing function corresponding to the recognized touch input. The editing function may include ‘delete’, ‘space’, ‘join’, ‘paste’, ‘replace’, ‘cut and paste’, and ‘decorate’. For example, the storing unit 203 may store an editing function corresponding to the correction code, and the discernment unit 202 may discern, in the storing unit 203, the editing function corresponding to the correction code associated with the touch input.

In operation S1030, the editing unit 204 may edit data provided on the screen according to the discerned editing function. For example, the editing unit 204 may delete data according to the discerned editing function, insert or delete a space between data, replace the data with other data, move the deleted data to other positions, or change a font property of the data.

The method of editing data according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A handheld terminal, comprising:
a recognition unit to recognize a touch input associated with a correction code on a screen;
a discernment unit to discern an editing function corresponding to the recognized touch input; and
an editing unit to edit data provided on the screen according to the discerned editing function.

2. The handheld terminal of claim 1, further comprising:
a storing unit to store the editing function associated with the correction code,
wherein the discernment unit is configured to discern the editing function corresponding to the correction code in the storing unit.

3. The handheld terminal of claim 1, wherein
the touch input comprises coordinate information, and
the editing unit is configured to delete data in the coordinate information when the editing function is discerned as ‘delete’ by the discernment unit.

4. The handheld terminal of claim 1, wherein
the touch input comprises coordinate information, and
the editing unit is configured to insert a whitespace in a position corresponding to the coordinate information when the editing function is discerned as ‘space’ by the discernment unit.

5. The handheld terminal of claim 1, wherein
the touch input comprises coordinate information, and
the editing unit is configured to delete a whitespace in a position corresponding to the coordinate information when the editing function is discerned as ‘join’ by the discernment unit.

6. The handheld terminal of claim 1, further comprises:
a data input unit to input data, wherein
the editing unit is configured to delete data in the coordinate information, and insert the inputted data to replace the deleted data when the editing function is discerned as ‘insert’ by the discernment unit; and
wherein the touch input comprises coordinate information.

7. The handheld terminal of claim 1, further comprises:
a list providing unit to provide a data list including data, and
a data selection unit to select first data from the provided data list, wherein
the editing unit is configured to insert the selected first data in a position corresponding to the coordinate information when the editing function is discerned as ‘replace’ by the discernment unit; and
wherein the touch input comprises coordinate information.

8. The handheld terminal of claim 1, further comprises:
a coordinate input unit to input second coordinate information, wherein
the editing unit is configured to delete data included in the first coordinate information and insert the deleted data in a position corresponding to the second coordinate information when the editing function is discerned as ‘cut and paste’ by the discernment unit; and
wherein the touch input comprises first coordinate information.

9. The handheld terminal of claim 1, further comprises:
a font providing unit to provide a font property comprising any one of a character type, a color, a shadow, a size, and an emphasis, and
a font selection unit to select the font property comprising any one of the character type, the color, the shadow, the size, and the emphasis, wherein
the editing unit is configured to replace the data included in the coordinate information with the selected font property when the editing function is discerned as ‘decorate’ by the discernment unit; and
wherein the touch input comprises coordinate information.

10. A method of editing data, comprising:
recognizing a touch input associated with a correction code on a screen; discerning an editing function corresponding to the recognized touch input; and editing data provided on the screen according to the discerned editing function.

11. The method of claim 10, further comprising:
storing the editing function associated with the correction code in a storing unit,
wherein the discerning comprises discerning, in the storing unit, the editing function corresponding to the correction code.

12. The method of claim 10, wherein
the touch input comprises coordinate information, and
when the editing unit is discerned as ‘delete’, the editing deletes data in the coordinate information.

13. The method of claim 10, wherein
the touch input comprises coordinate information, and
when the editing function is discerned as ‘space’, the editing inserts a whitespace in a position corresponding to the coordinate information.

14. The method of claim 10, wherein
the touch input comprises coordinate information, and
when the editing function is discerned as ‘join’, the editing deletes a whitespace in a position corresponding to the coordinate information.

15. The method of claim 10, wherein
the touch input comprises coordinate information, and
when the editing function is discerned as ‘insert’ by a discernment unit, the editing comprises:
deleting data in the coordinate information,
inputting data, and
inserting the inputted data to replace the deleted data.

16. The method of claim 10, wherein
the touch input comprises coordinate information, and
when the editing function is discerned as ‘replace’, the editing comprises:
providing a data list comprising data,
selecting first data from the provided data list, and
inserting the selected first data in a position corresponding to the coordinate information.

17. The method of claim 10, wherein
the touch input comprises first coordinate information, and
when the editing function is discerned as ‘cut and paste’, the editing comprises:
deleting data in the first coordinate information,
inputting second coordinate information, and
inserting the deleted data in a position corresponding to the second coordinate information.

18. The method of claim 10, wherein the touch input comprises coordinate information, and
when the editing unit is discerned as ‘decorate’, the editing comprises:
providing a font property that comprises any one of a character type, a color, a shadow, a size, and an emphasis,
selecting the font property that comprises any one of the character type, the color, the shadow, the size, and the emphasis, and
replacing the data in the coordinate information with the selected font property.
